(19) United States
(12) Patent Application Publication
(10) Pub. No.: US 2018/0169955 A1
(43) Pub. Date: Jun. 21, 2018

(54) METHOD AND EQUIPMENT FOR GENERATING A NUMERICAL REPRESENTATION OF A THREE-DIMENSIONAL OBJECT, SAID NUMERICAL REPRESENTATION BEING SUITED TO BE USED FOR MAKING SAID THREE-DIMENSIONAL OBJECT THROUGH STEREOLITHOGRAPHY

(71) Applicant: DWS S.R.L., Thiene (VI) (IT)

(72) Inventor: Alessandro Marozin, Breganze (VI) (IT)

(21) Appl. No.: 15/128,380

(22) PCT Filed: Mar. 20, 2015
(86) PCT No.: PCT/IB2015/052066

§ 371 Date: Sep. 22, 2016

(30) Foreign Application Priority Data
Mar. 24, 2014 (IT) VI2014A000067

(51) Int. Cl. B29C 64/40; B29C 64/386; B29C 64/135; B33Y 50/00; G06F 17/50

(52) U.S. Cl. CPC B29C 64/40; B29C 64/386; B29C 64/135; G06F 2217/16; G06F 17/50; G06F 2217/12; B33Y 50/00

(57) ABSTRACT

Method for generating a numerical representation of a three-dimensional object (11) to be made through stereolithography, comprising the following operations: preparing a first set of data (1) representative of the geometry of the object (11); defining first surfaces (13, 13a) of the object (11) and reference surfaces (14, 14a) facing them; defining a first point (X1) on the first surface (13, 13a), a second point (X2) on the corresponding reference surface (14, 14a) and geometric parameters (P1 . . . Pn) that define the three-dimensional geometry of a corresponding supporting element (15) that connects the first point (X1) to the second point (X2); generating a third set of data (3) containing the coordinates (7) of the first point (X1) and of the second point (X2) and the values (8) of the geometric parameters (P1 . . . Pn) of each supporting element (15); generating a numerical representation of each supporting element (15) based on the third set of data (3); calculating a second set of data (2) representative of the geometry resulting from the union of the object (11) with the supporting elements (15).

The present invention concerns a method for generating a set of data representative of the geometry of a three-dimensional object to be produced through stereolithography.

The present invention concerns also a piece of equipment for generating said set of data, as well as a computer program product suited to be loaded in a computer in order to make it suitable for the implementation of said method.

As is known, a stereolithography process consists in making a three-dimensional object through the sequential superimposition of several layers of the same object.

Each layer of the object is obtained through solidification, by selectively exposing to light radiation a material in the liquid or paste state in contact with the previous solidified layer that serves as a support.

Generally, the process requires that supporting elements are provided in order to connect one or more surfaces of the three-dimensional object to corresponding reference surfaces facing them.

Said supporting elements make it possible to avoid the collapse and/or deformation of those areas of the new layers to be solidified that are not directly supported by the already solidified layers.

Said process is controlled by a computer to which a first set of data representative of the geometry of the object to be produced is supplied.

The computer executes a program that adds the supporting elements more or less automatically and generates a second set of data representative of the three-dimensional geometry resulting from the union of the object with the supporting elements.

Said second set of data is then used by the stereolithography device for actually making the object.

A drawback of said known method lies in that, often, the supporting elements defined in this way do not have an optimal geometry.

In particular, it may happen that the resisting cross section of the supporting elements is excessive, causing an excessive use of material and increasing the time necessary to make the object, in addition to creating more difficulties when the object is cleaned at the end of the process.

In other cases, for example at the level of especially critical areas of the object, it may happen that the resisting cross section of the respective supporting elements is insufficient and causes damage to the object during its production. Furthermore, it should be considered that the geometry of the supporting elements depends also on the material used to make the three-dimensional object.

It can therefore happen that, once having generated the supporting elements based on a given material to be used, the operator successively decides to change the material, thus making it necessary to modify the supporting elements.

In the cases described above, according to the known technique the operator modifies the geometry of the object resulting after the addition of the supporting elements by adding or removing material in the areas corresponding to the supporting elements, these operations being carried out by means of a suitable 3D modeller that transfers the corresponding modifications to the second set of data.

The operation just mentioned above poses the drawback that it is rather complicated and requires a considerable calculation time.

A known alternative consists in modifying the parameters used by the program for generating the supporting elements before defining the latter and successively re-generating the second set of data.

However, said alternative requires in any case a first generation of the second set of data and, furthermore, does not allow the supporting elements to be modified individually.

The present invention intends to overcome the drawbacks mentioned above that belong to the known art.

In particular, it is the object of the present invention to provide a method for generating a numerical representation of a three-dimensional object provided with supporting elements that allows the operator to easily modify the supporting elements.

It is a further object of the present invention to provide a method that allows the operator to modify the supporting elements before generating the data base that defines the three-dimensional geometry representing the union of the objects with the supports.

It is also the object of the present invention to provide a method that allows the operator to easily modify each supporting element independently of the other ones.

Said objects are achieved by a method according to claim 1.

Further characteristics and details of the method that is the subject of the invention are described in the related dependent claims.

Said objects are also achieved by a piece of equipment according to claim 12, as well as by a computer program product according to claim 13.

Advantageously, the possibility to easily modify the supporting elements once they have been defined and before the generation of the second data base allows the operator to design the same supporting elements more rapidly.

Still advantageously, the operator can easily optimize the geometry of the supporting elements, in such a way as to limit the time that is necessary to produce the three-dimensional object through stereolithography and the material used in said process.

Said objects and advantages, together with others that are highlighted here below, will be clear from the description of a preferred embodiment of the invention that is provided by way of non-limiting example with reference to the attached drawings, wherein:

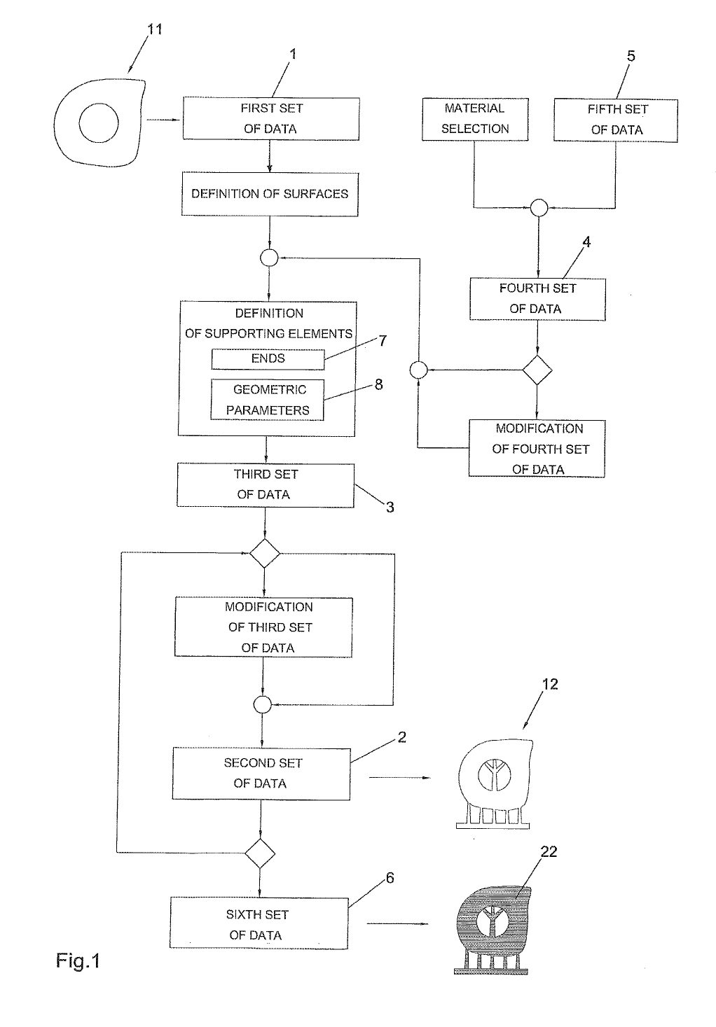

FIG. 1 schematically shows the method of the invention;

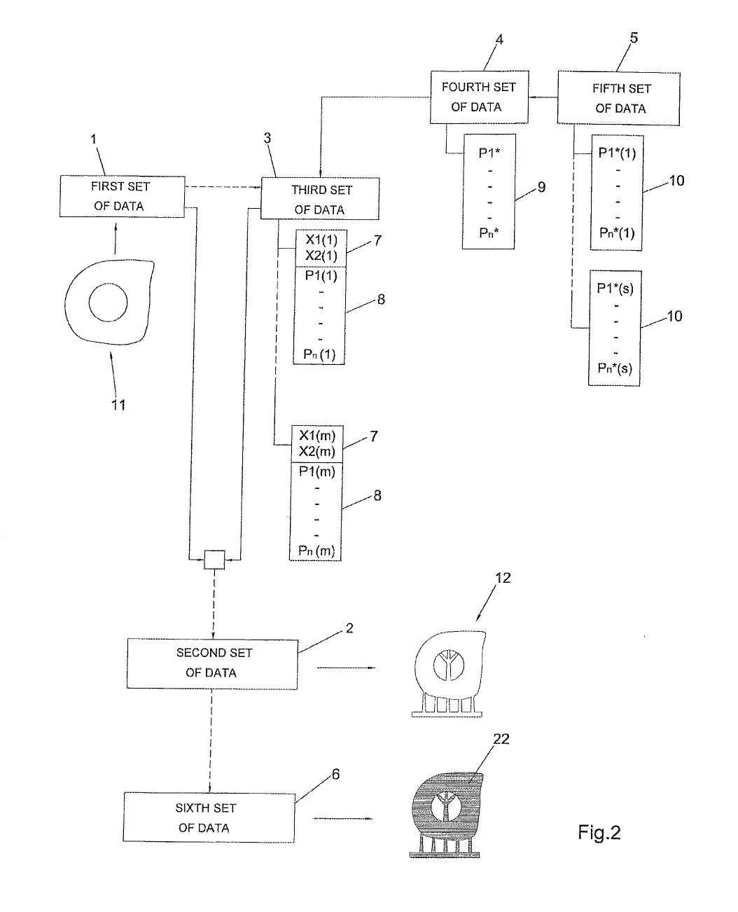

FIG. 2 schematically shows the structure of the data used in the method of the invention;

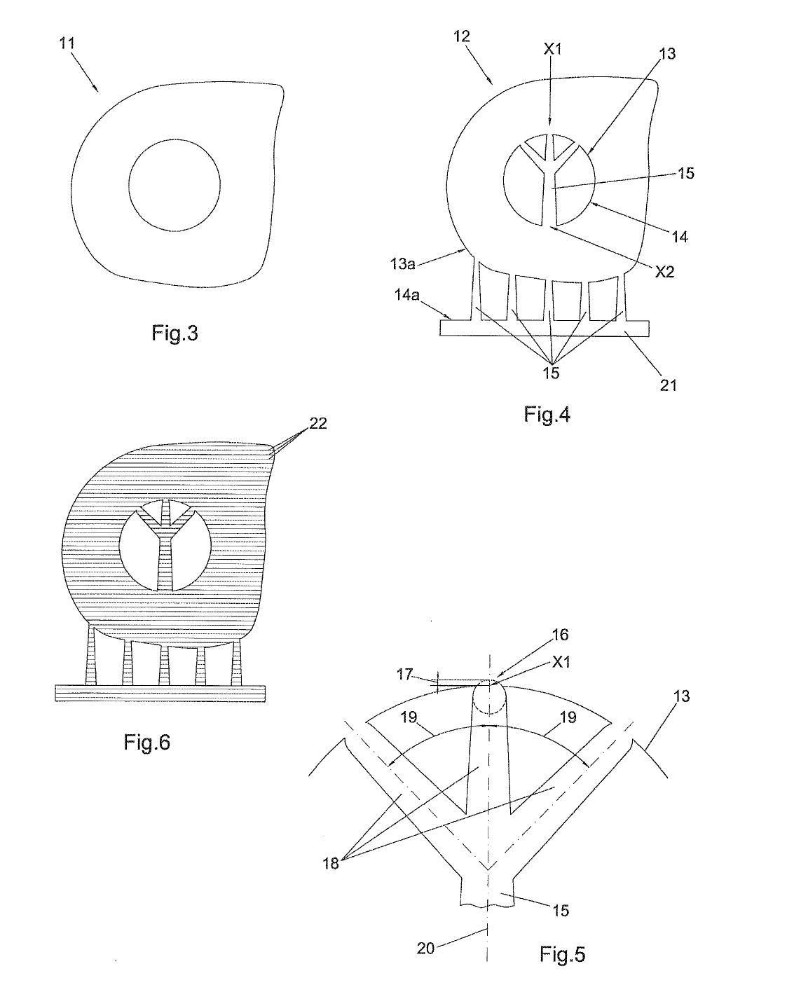

FIG. 3 shows a three-dimensional object;

FIG. 4 shows a three-dimensional object obtained by joining the three-dimensional object shown in FIG. 3 to a plurality of supporting elements;

FIG. 5 shows an enlarged detail of the three-dimensional object shown in FIG. 4;

FIG. 6 schematically shows the three-dimensional object of FIG. 4 subdivided into layers.

The method that is the subject of the invention, intended to generate a numerical representation of a three-dimensional object 11 to be produced through stereolithography, is schematically represented in FIG. 1 and comprises the operations described below.

First of all, the method includes the operation of preparing a first set of data 1 representative of the geometry of the three-dimensional object 11 to be made, a merely indicative example of which is shown in FIG. 3.

Successively, one or more first surfaces 13, 13a of the three-dimensional object 11 are defined, which need to be supported and are indicated in FIG. 4 by way of example.

Obviously, the first surfaces 13, 13a can be defined both by means of a mathematical algorithm and through manual selection performed by the operator.

Analogously, reference surfaces 14, 14a are defined that face said first surfaces 13, 13a and are suited to support them.

The reference surfaces 14, 14a can be defined as a corresponding number of surfaces of the three-dimensional object 11, or as surfaces that are separate from the three-dimensional object 11 itself.

The first option is preferably adopted for a first surface 13 that belongs to a cavity created inside the three-dimensional object 11.

In this case, the corresponding reference surface 14 is the opposite surface belonging to the same cavity.

The second option is preferably adopted when the first surface 13a is external to the three-dimensional object 11.

In this second case, the corresponding reference surface 14a is defined so that it is positioned at a certain distance from the initial three-dimensional object 11. In this case, said reference surface 14a preferably belongs to a supporting base 21 that is generated outside the three-dimensional object 11.

Said supporting base 21, indicated in FIG. 4, serves for resting the object on the modelling platform of the stereolithography machine during production of the three-dimensional object itself, with the aim to improve the adhesion of the latter to the platform itself.

The method furthermore includes the operation of defining a plurality of supporting elements 15 that connect the first surfaces 13, 13a to the corresponding reference surfaces 14, 14a, illustrated by way of example in FIG. 4.

The method furthermore includes the operation of calculating a second set of data 2 representative of a modified three-dimensional object 12 resulting from the union of the three-dimensional object 11 with the plurality of supporting elements 15 as defined above and with the supporting base 21, if any.

According to the invention, the supporting elements 15 are defined through corresponding geometric parameters.

More precisely, for each supporting element 15 the following are defined: a first point X1 on the corresponding first surface 13, 13a, a second point X2 on the corresponding reference surface 14, 14a and n geometric parameters P1 . . . Pn suited to completely define the three-dimensional geometry of the supporting element 15 itself based on a conventional description of the supporting elements.

Clearly, n can vary from one to any number, based on the number of degrees of freedom that are going to be used to describe the supporting elements 15.

An example of usable geometric parameters is provided further on.

It can be understood that each supporting element 15 is completely defined by the coordinates 7 of the terminal points X1 and X2 and by the geometric parameters P1 . . . Pn that define its three-dimensional development.

In particular, the definition of the supporting elements 15 comprises the generation of a third set of data 3 containing said coordinates 7, as well as the values 8 of the geometric parameters P1 . . . Pn for each supporting element 15. Said third set of data 3 is used to generate the numerical representation of each supporting element 15, which is then used in the calculation of the second set of data 2.

The structure of the data as described above is schematically represented in FIG. 2, where the coordinates of the points X1 and X2 and the geometric parameters P1 . . . Pn corresponding to each supporting element 15 have been conventionally identified through indices from 1 to m in parentheses, where m is the number of supporting elements 15.

In other words, the coordinates of the terminal points and the geometric parameters of the i-th supporting element are conventionally indicated by X1(i), X2(i) and P1(i) . . . Pn(i).

It can be understood that said data structure makes it possible to modify any i-th supporting element 15 by modifying the related geometric parameters P1(i) . . . Pn(i).

This makes it possible to modify the geometry of the supporting elements 15 in a simple, rapid and interactive manner, even after they have been defined and before the calculation of the second set of data 2.

Furthermore, the fact that each supporting element 15 is defined through specific geometric parameters allows the supporting element to be modified independently of the other supporting elements 15, thus achieving another object of the invention.

Therefore, the method preferably comprises the operation of modifying the third set of data 3 so as to modify the values 8 of one or more geometric parameters P1 . . . Pn corresponding to at least one of the supporting elements 15.

Successively, the numerical representation of the modified supporting element 15 is re-generated and then the second set of data 2 is updated.

Advantageously, said update does not require the complete re-calculation of the second set of data 2, making it possible to limit the re-generation only to the modified supporting element 15.

Preferably, the definition of the supporting elements 15 includes the generation of a fourth set of data 4 containing a reference value 9 for each geometric parameter P1 . . . Pn. The geometric parameters corresponding to said reference values 9 are indicated by P1* . . . Pn* in FIG. 2, in order to differentiate them from the geometric parameters of each supporting element 15.

Said reference values 9 are used in the generation of the third set of data 3, assigning to each geometric parameter P1 . . . Pn corresponding to each supporting element 15 the corresponding reference value 9 of the fourth set of data 4.

Said fourth set of data 4 advantageously makes it possible to initially assign the same reference values 9 to the parameters P1 . . . Pn of all the supporting elements 15.

Clearly, the reference values 9 can be defined based on the geometry of the three-dimensional object 11, on the material that is going to be used to make it, on the thickness of each layer into which the three-dimensional object is going to be subdivided for production, etc.

Preferably, the method includes also the operation of modifying the fourth set of data 4 in such a way as to modify the reference value 9 corresponding to one or more geometric parameters P1* . . . Pn*.

The reference values 9 modified in this way can be assigned to the corresponding geometric parameters P1 . . . Pn of two or more supporting elements 15, preferably of all the supporting elements 15, through the corresponding modification of the third set of data 3.

Successively, the calculation of the second set of data 2 will be repeated based on the third set of data 3 modified as indicated above.

It can be understood that the possibility to modify the fourth set of data 4 advantageously makes it possible to modify two or more supporting elements 15 with a single operation.

Preferably, the method includes also the definition of a fifth set of data 5 containing a set of predefined reference values 10 of the geometric parameters P1 . . . Pn for each material of a plurality of materials suited to be used to make a generic three-dimensional object through stereolithography and identified in advance.

In FIG. 2, the geometric parameters of each set have been indicated with an asterisk and with an index from 1 to s in parentheses, where s is the number of different materials.

In other words, the set of geometric parameters related to the j-th material is indicated by P1*(j) . . . Pn*(j).

Preferably, the generation of the fourth set of data 4 includes the operation of selecting one of said materials and assigning to the reference values 9 of the fourth set of data 4 the corresponding predefined reference values 10 corresponding to the material itself and contained in the fifth set of data 5.

Advantageously, the fifth set of data 5 described above makes it possible to simply and rapidly assign the reference values 9 to the geometric parameters P1 . . . Pn of the supporting elements 15, based on the type of material with which the three-dimensional object 11 is going to be made.

Preferably, said first, second and third set of data 1, 2 and 3 are stored in a memory support of a computer.

Preferably, also the sets of data 4 and 5 are stored in the same memory support.

As regards the geometric parameters P1 . . . Pn, they preferably comprise one or more of the following parameters:
transverse dimension of the generic supporting element 15;
ratio between the transverse dimension of the supporting element 15 and the length of the supporting element 15;
size of a sphere 16 that defines at least one end of the supporting element 15, as indicated in FIG. 5;
interpenetration depth 17 of said sphere 16 in the corresponding first surface 13, 13a or in the corresponding reference surface 14, 14a of the supporting element 15;
maximum number of branches 18 at the level of at least one end of the supporting element 15;
maximum inclination 19 of said branches 18 with respect to the direction of development 20 of the supporting element 15.

Clearly, further geometric parameters representative of a corresponding number of geometric aspects of the supporting elements 15 can be added to said list.

Preferably, the second set of data 2 obtained with the method described above is used in a process for making the three-dimensional object 11 through stereolithography.

According to this process, a sixth set of data 6 is calculated that is representative of a plurality of bidimensional and mutually parallel cross sections 22 of the three-dimensional object described by the second set of data 2, as shown in FIG. 6 merely by way of example.

Therefore, the sixth set of data 6 includes, in addition to the three-dimensional object 11, also the supporting elements 15 and the supporting base 21, if any.

Said sixth set of data 6 is then used in a stereolithography machine to obtain a plurality of solid layers corresponding to said plurality of bidimensional cross sections 22.

As already mentioned, the invention concerns also a piece of equipment for the generation of said numerical representation of the three-dimensional object 11.

Said equipment comprises a computer, not illustrated herein but known per se, provided with a processing unit and a memory support that can be accessed by the processing unit.

The equipment comprises also means for acquiring the first set of data 1 representative of the geometry of the three-dimensional object 11 and for loading it in the memory support.

The equipment comprises also means for defining the first surfaces 13, 13a and the reference surfaces 14, 14a and means for defining the supporting elements 15.

In particular, the means for defining the supporting elements 15 comprise means for defining the first point X1, the second point X2 and the geometric parameters P1 . . . Pn of each supporting element 15 and means for generating the third set of data 3 and loading it in the memory support.

The equipment comprises also means for modifying the third set of data 3 as described above and means for calculating the second set of data 2 in the way described above and for loading it in the memory support.

In particular, the means for calculating the second set of data 2 comprise means for generating a numerical representation of each supporting element 15 based on said third set of data 3.

As already mentioned, the present invention concerns also a computer program product comprising a data support provided with program portions configured in such a way that, when executed on said computer, they configure it for the implementation of the method of the invention described above.

In particular, said program portions, when executed on the computer, define means for acquiring the first set of data 1 and loading it in the memory support, means for defining the first surfaces 13, 13a, the reference surfaces 14, 14a and the supporting elements 15 that connect them as described above, as well as means for calculating the second set of data 2 as described above and for loading it in the memory support.

In practice, the operator acquires the first set of data 1 representative of the three-dimensional object 11.

The first set of data 1 can be supplied in any format of the known type like, for example, DWG, STEP, IGES, PRT, STL or any other format, provided that it is suitable for the numerical representation of a three-dimensional geometry.

The first set of data 1 can be generated, for example, by a three-dimensional modelling program or by a three-dimensional optical reader or by any other device capable of generating a numerical representation of the three-dimensional object 11.

The operator stores the first set of data 1 in a piece of equipment of the type described above and starts the execution of the program loaded therein, which defines the supporting elements 15 and generates the corresponding third set of data 3.

If necessary, before starting said program, the operator can set the fourth set of data 4 containing the reference values 9 for the geometric parameters P1* . . . Pn*.

The equipment then makes said data available to the operator, preferably translated in a graphic format.

The operator can then modify the geometric parameters P1 . . . Pn of one or more supporting elements 15, modifying the third set of data 3, or modify a plurality of supporting elements 15 intervening on the reference values 9 contained in the fourth set of data 4.

Successively, the program generates the second set of data 2 representative of the three-dimensional object 11 with the supporting elements 15 modified as required by the user and with the supporting base 21, if any.

According to the above, it can be understood that the method and the equipment for the generation of the numerical representation and the computer program product described above achieve all of the set objects.

In particular, the definition of the supporting elements based on the terminal points and on geometric parameters that describe their three-dimensional configuration, as well as their organization in a third set of data, allow the shape of the supporting elements to be easily modified after their definition.

Furthermore, as the third set of data comprises geometric parameters of each supporting element that are independent of the geometric parameters of the remaining supporting elements, it is possible to easily modify each supporting element independently of the other ones.

1) Computer-implemented method for generating a numerical representation of a three-dimensional object (11) to be made through stereolithography, comprising the following operations:
preparing a first set of data (1) representative of the geometry of said three-dimensional object (11);
defining one or more first surfaces (13, 13a) of said three-dimensional object (11) and one or more corresponding reference surfaces (14, 14a) facing each one of said first surfaces (13, 13a);
defining a plurality of supporting elements (15) connecting said first surfaces (13, 13a) to said one or more corresponding reference surfaces (14, 14a);
calculating a second set of data (2) in such a way that the second set of data (2) is representative of the geometry resulting from the union of said three-dimensional object (11) with said plurality of supporting elements (15);
said operation of defining said plurality of supporting elements (15) comprising, for each one of said supporting elements (15), an operation of defining a corresponding first point (X1) belonging to said supporting element (15) on a corresponding first surface (13, 13a) and a corresponding second point (X2) belonging to said supporting element (15) on the corresponding reference surface (14, 14a);
characterized in that said operation of defining said plurality of supporting elements (15) comprises the following operations:
for each one of said supporting elements (15), defining one or more corresponding geometric parameters (P1 . . . Pn) suited to completely define, in combination with the corresponding said first point (X1) and said corresponding second point (X2), a three-dimensional configuration of said supporting element (15);
generating a third set of data (3) containing the coordinates (7) of said first point (X1) and of said second point (X2) and the values (8) of said geometric parameters (P1 . . . Pn) of each one and all of said supporting elements (15);
rendering said third set of data (3) available to an operator for modification before performing said operation of calculating said second set of data (2), said modification comprising modifying the values (8) of one or more geometric parameters (P1 . . . Pn) corresponding to at least one supporting element (15) of said plurality of supporting elements (15), independently of the geometric parameters (P1 . . . Pn) corresponding to the other supporting elements (15);
said operation of calculating said second set of data (2) comprising the generation of a numerical representation for each supporting element (15) based on said third set of data (3).

2) (canceled)

3) Method according to claim 1, characterized in that:
said operation of defining said plurality of supporting elements (15) includes generation of a fourth set of data (4) containing a reference value (9) for each one of said geometric parameters (P1 . . . Pn);
said generation of said third set of data (3) comprising assignment of said reference values (9) to the corresponding geometric parameters (P1 . . . Pn) of each supporting element (15).

4) Method according to claim 3, characterized in that said operation of defining said plurality of supporting elements (15) comprises the following operations:
modifying said fourth set of data (4) so as to modify the reference value (9) corresponding to at least one of said geometric parameters (P1 . . . Pn);
modifying said third set of data (3) so as to assign said modified reference value (9) to said at least one of said geometric parameters (P1 . . . Pn) of at least two of said supporting elements (15).

5) Method according to claim, characterized in that the method comprises the following operations:
identifying a plurality of materials suited to be used to produce said three-dimensional object (11) through stereolithography;
defining a fifth set of data (5) containing, for each one of said materials, a corresponding set of predefined reference values (10) for said geometric parameters (P1 . . . Pn);
said generation of said fourth set of data (4) including selection of a material belonging to said plurality of materials, and assignment of the predefined reference values (10) corresponding to said material to said fourth set of data (4).

6) Method according to claim 1, characterized in that it includes an operation of storing said first set of data (1), second set of data (2) and third set of data (3) in a memory support of a computer.

7) Method according to claim 1, characterized in that said geometric parameters (P1 . . . Pn) comprise one or more of the following parameters:
a transverse dimension of a supporting element (15);
a ratio between the transverse dimension of a supporting element (15) and a length of the supporting element (15);
a size of a sphere (16) defining at least one of the ends of a supporting element (15);
an interpenetration depth (17) of said sphere (16) in the corresponding first surface (13, 13a) or in the corresponding reference surface (14, 14a);
a maximum number of branches (18) of a supporting element (15) at the level of at least one of said ends;
a maximum inclination (19) of said branches (18) with respect to a direction of development (20) of the supporting element (15).

8) Method according to claim 1, characterized in that at least one of said reference surfaces (14) is a surface of said three-dimensional object (11).

9) Method according to claim 1, characterized in that at least one of said reference surfaces (14a) is a surface that is separate from said three-dimensional object (11).

10) Method according to claim 9, characterized in that said calculation of said second set of data (2) comprises the following operations:
defining a supporting base (21) comprising said at least one reference surface (14, 14a);
calculating said second set of data (2) in such a way that it is representative of a geometry resulting from a union of said three-dimensional object (11) with said plurality of supporting elements (15) and with said supporting base (21).

11) Method for making a three-dimensional object (11), characterized in that it comprises the following operations:
applying a method according to claim 1 for generating a second set of data (2) representative of said three-dimensional object (11);
calculating a sixth set of data (6) representative of a plurality of bidimensional and mutually parallel cross sections (22) of the three-dimensional object represented by said second set of data (2);
using said sixth set of data (6) in a stereolithography machine in such a way as to obtain a plurality of solid layers respectively corresponding to said plurality of bidimensional cross sections (22).

12) Equipment for generating a numerical representation of a three-dimensional object (11) to be made through stereolithography, comprising:
a computer comprising a processing unit and a memory support accessible by said processing unit;
means for acquiring a first set of data (1) representative of the geometry of said three-dimensional object (11) and for loading said first set of data in said memory support;
means for defining one or more first surfaces (13, 13a) of said three-dimensional object (11) and one or more corresponding reference surfaces (14, 14a) facing each one of said first surfaces (13, 13a);
means for defining a plurality of supporting elements (15) connecting each one of said first surfaces (13, 13a) to said one or more corresponding reference surfaces (14, 14a);
means for calculating said second set of data (2) in such a way that the second set of data (2) is representative of a geometry resulting from a union of said three-dimensional object (11) with said plurality of supporting elements (15) and for loading said second set of data in said memory support;
wherein said means for defining said plurality of supporting elements (15) comprises means for defining, for each one of said supporting elements (15), a corresponding first point (X1) of said supporting element (15) on the corresponding first surface (13, 13a) and a corresponding second point (X2) of said supporting element (15) on the corresponding reference surface (14, 14a);
characterized in that said means for defining said plurality of supporting elements (15) comprise:
means for defining, for each one of said supporting elements (15), one or more corresponding geometric parameters (P1 . . . Pn) suited to completely define, in combination with the corresponding said first point (X1) and said second point (X2), the three-dimensional configuration of said supporting element (15);
means for generating a third set of data (3) containing coordinates of said first point (X1) and of said second point (X2) and values (8) of said geometric parameters (P1 . . . Pn) of each one and all of said supporting elements (15), and for loading said third set of data in said memory support;
means for allowing an operator to modify said third set of data (3) so as to modify the values (8) of one or more geometric parameters (P1 . . . Pn) corresponding to at least one supporting element (15) of said plurality of supporting elements (15) independently of the geometric parameters (P1 . . . Pn) corresponding to the other supporting elements (15);
said means for calculating said second set of data (2) comprising means for generating a numerical representation of each supporting element (15) based on said third set of data (3).

13) Computer program product comprising a data support provided with program portions configured in such a way that, when executed on a computer comprising a processing unit and a memory support accessible by said processing unit, said program portions define:
means for acquiring a first set of data (1) representative of geometry of a three-dimensional object (11) and for loading said first set of data in said memory support;
means for defining one or more first surfaces (13, 13a) of said three-dimensional object (11) and one or more corresponding reference surfaces (14, 14a) facing each one of said first surfaces (13, 13a);
means for defining a plurality of supporting elements (15) connecting each one of said first surfaces (13, 13a) to the corresponding reference surface (14, 14a);
means for calculating a second set of data (2) so that the second set of data (2) is representative of the geometry resulting from the union of said three-dimensional object (11) with said plurality of supporting elements (15) and for loading said second set of data in said memory support;
wherein said means for defining said plurality of supporting elements (15) comprises means for defining, for each one of said supporting elements (15), a corresponding first point (X1) of said supporting element (15) on the corresponding first surface (13, 13a) and a corresponding second point (X2) of said supporting element (15) on the corresponding reference surface (14, 14a);
characterized in that said means for defining said plurality of supporting elements (15) comprise:
means for defining, for each one of said supporting elements (15), one or more corresponding geometric parameters (P1 . . . Pn) suited to completely define, in combination with the corresponding said first point (X1) and said second point (X2), a three-dimensional configuration of said supporting element (15);
means for generating a third set of data (3) containing coordinates of said first point (X1) and of said second point (X2) and values (8) of said geometric parameters (P1 . . . Pn) of each one of said supporting elements (15), and for loading said third set of data in said memory support;
means for allowing an operator to modify said third set of data (3) so as to modify the values (8) of one or more geometric parameters (P1 . . . Pn) corresponding to at least one supporting element (15) of said plurality of supporting elements (15) independently of the geometric parameters (P1 . . . Pn) corresponding to the other supporting elements (15);
said means for calculating said second set of data (2) comprising means for generating a numerical representation of each supporting element (15) based on said third set of data (3).
